(19) United States
(12) Patent Application Publication
(10) Pub. No.: US 2025/0351773 A1
(43) Pub. Date: Nov. 20, 2025

(54) DEVICES, SYSTEMS, AND METHODS FOR CORN HEADERS

(71) Applicant: Ag Leader Technology, Ames, IA (US)

(72) Inventor: Roger Zielke, Huxley, IA (US)

(21) Appl. No.: 19/281,156

(22) Filed: Jul. 25, 2025

Related U.S. Application Data
(62) Division of application No. 17/225,586, filed on Apr. 8, 2021.
(60) Provisional application No. 63/006,774, filed on Apr. 8, 2020.

(51) Int. Cl. A01D 45/02; A01D 41/127; G01B 21/06; G01D 21/00

(52) U.S. Cl. CPC A01D 45/021; A01D 41/127; A01D 41/1273; G01B 21/06; G01D 21/00

(57) ABSTRACT

A method for controlling header height comprising generating a signal as an object passes through a row unit; establishing a signal threshold, wherein when the signal threshold is exceeded a shelled ear event is detected; comparing the signal to the signal threshold; and emitting an alarm with the signal exceeds the signal threshold.

### CROSS-REFERENCE TO RELATED APPLICATION(S)

This application is a division of U.S. Ser. No. 17/225,586, filed Apr. 8, 2021, entitled “Devices, Systems, and Methods for Corn Headers,” which claims the benefit under 35 U.S.C. § 119(e) to U.S. Provisional Application 63/006,774, filed Apr. 8, 2020, and entitled Agricultural Devices, Systems, and Methods, each of which is hereby incorporated herein by reference in its entirety for all purposes.

### TECHNICAL FIELD

The disclosure relates to various devices, systems, and methods for use in agricultural applications, particularly for use during agricultural harvest and in conjunction with corn headers.

### BACKGROUND

It is appreciated by those of skill in the art that when a corn ear enters a harvester row unit at or slightly below the stripper plate, the stalk rolls may thresh or shell off kernels from the ear. These loose kernels may then fall to the ground and become unwanted header loss-lost yield. This harvesting error often goes undetected because it is typically only a periodic problem and in most circumstances is difficult to see from the cab.

There is a need in the art for improved devices, systems, and methods for minimizing loss during agricultural harvest.

### BRIEF SUMMARY

Disclosed herein are various devices, systems, and methods for improving and monitoring yields during agricultural harvests.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example 1 relates to a header warning system for a corn head comprising a plurality of row units, the header warning system comprising an operations unit comprising a processor and memory, and a plurality of sensing members, wherein at least one of the plurality of sensing members is disposed on one or more of the plurality of row units, wherein the plurality of sensing members are configured to detect shelled ear events (E_{d}).

In Example 2, the system of Example 1, wherein a shelled ear event is detected when at least one of the plurality of sensing members is deflected for a period of time greater than a threshold period of time.

In Example 3, the system of Example 1, wherein a shelled ear event is detected when at least one of the plurality of sensing members detect a stalk size greater than a threshold size.

In Example 4, the system of Example 3, wherein the stalk size is a diameter and a threshold diameter is about 1.5 inches.

In Example 5, the system of Example 1, further comprising a display in operative communication with the plurality of row units.

In Example 6, the system of Example 5, wherein the display is configured to emit ta signal when the number of shelled ear events exceeds a predetermined threshold.

In Example 7, the system of Example 6, wherein the signal is at least one of an auditory or visual alarm.

Example 8 relates to a system for minimizing yield loss comprising a row unit on a corn header. The row unit comprising a pair of stripper plates defining a stripper plate gap on the row unit and at least one sensing member attached to the row unit, the at least one sensing member configured to measure one or more harvest metrics. The system also comprising a display comprising at least one processor, and wherein the display is configured to visualize and/or emit an alarm when a shelled ear event is detected.

In Example 9, the system of Example 8, wherein the at least one sensing member is attached to the row unit below the pair of stripper plates.

In Example 10, the system of Example 8, wherein the one or more harvest metrics include one or more of stalk diameter, stalk perimeter, deflection time, and stalk width.

In Example 11, the system of Example 8, wherein a shelled ear event is detected when the at least one sensing member detects a diameter that exceeds a threshold diameter.

In Example 12, the system of Example 8, wherein a shelled ear event is detected when the at least one sensing member is deflected for a period of time that exceeds a threshold period of time.

In Example 13, the system of Example 8, further comprising a header adjustment system configured to adjust the corn header height.

In Example 14, the system of Example 13, wherein the corn header height is lowered in response to detecting a shelled ear event.

Example 15 relates to a method for controlling header height comprising: generating a signal as an object passes through a row unit, establishing a signal threshold, wherein when the signal threshold is exceeded a shelled ear event is detected, comparing the signal to the signal threshold, and emitting an alarm with the signal exceeds the signal threshold.

In Example 16, the method of Example 15, wherein the signal comprises at least one of a stalk size, a deflection distance, and a deflection time.

In Example 17, the method of Example 15, further comprising ceasing the alarm when the signal no longer exceeds the signal threshold.

In Example 18, the method of Example 15, wherein the alarm is emitted when the signal exceeds the signal threshold after a time threshold is exceeded.

In Example 19, the method of Example 15, further comprising adjusting a header height in response to the alarm.

In Example 20, the method of Example 19, wherein the header height is incrementally lowered in response to the alarm.

In various implementations, the system defines or accesses a threshold (Dₜ) for use, and in certain implementations the threshold (Dₜ) can relate to measured stalk data or other parameters, certain non-limiting examples including stalk data such as width, diameter, time or other quantifiable or qualifiable limits, certain of which can be a range of values or properties, as would be understood.

In various implementations, the system utilizes measured stalk data (Dₘ) such as size, diameter, perimeter, deflection time, and/or width to detect shelled ear events (E_{d}), when Dₘ>Dₜ.

In certain implementations, the system defines a start of the shelled ear event (E_{di}) when a threshold (Dₜ) is exceeded. The system according to certain implementations may also determine the end of a shelled ear event (E_{df}) when one or more measured stalk data (Dₘ), such as diameter, size, or deflection time, returns to below or within a defined threshold (Dₜ) range.

In various implementations, the system defines or accesses an event threshold (Eₜ). Certain non-limiting examples of an event threshold (Eₜ) being a certain number of events (E_{d}) have been recorded; when a shelled ear event (E_{d}) lasts for a certain period of time or exceeds a time event threshold (Eₜ); or when another algorithmic parameter is met or has been exceeded as defined by the particular implementation of the system in operation.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a top view of a harvester, according to one implementation.

FIG. 1B is a schematic representation of one implementation of an operations unit.

FIG. 2 shows a top view of a row unit, according to one implementation.

FIG. 3 shows a top view of a row unit, according to one implementation.

FIG. 4A depicts a schematic drawing of a stalk passing through sensing members, according to one implementation.

FIG. 4B depicts a further schematic drawing of a stalk passing through sensing members, according to one implementation.

FIG. 4C depicts yet another schematic drawing of a stalk passing through sensing members, according to one implementation.

FIG. 5A depicts a schematic drawing of a stalk passing through sensing members, according to one implementation.

FIG. 5B depicts another schematic drawing of a stalk passing through sensing members, according to one implementation.

FIG. 5C depicts yet another schematic drawing of a stalk passing through sensing members, according to one implementation.

FIG. 6A shows a top perspective view of a row unit during a shelled ear event, according to one implementation.

FIG. 6B shows a top perspective view of a row unit during a shelled ear event, according to another implementation.

FIG. 6C shows a top perspective view of a row unit during a shelled ear event, according to a further implementation.

FIG. 7 shows a systematic diagram of the system, according to one implementation.

### DETAILED DESCRIPTION

Discussed herein are various devices, systems, and methods for increasing yield by minimizing loss due to harvester error. In various implementations, a system is provided for emitting warnings/alarms when the corn head is not at an optimal height, such that yield is not lost due to shelling/threshing of ears by the stripper plates and/or stalk rolls.

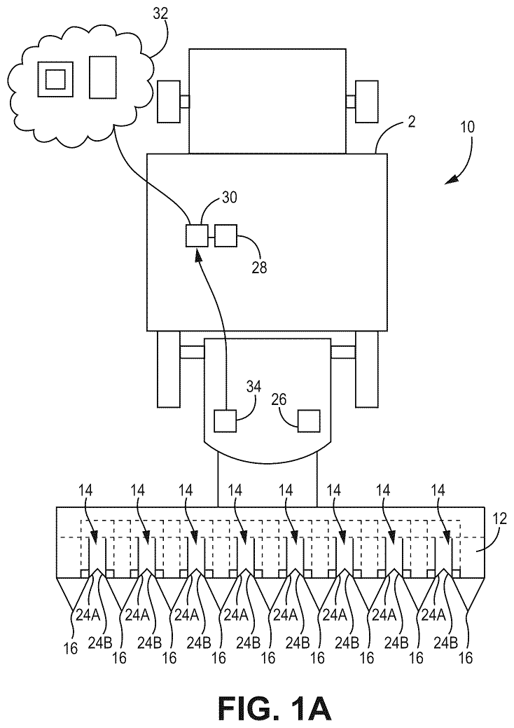

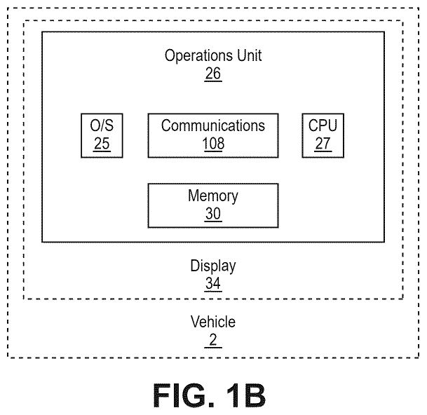

Turning now to FIGS. 1A-1B, it is readily appreciated that the disclosed header warning system 10 may be used in connection with any known harvester 2. A harvester 2 having a header 12 and header warning system 10 may be configured to harvest row crops. In various implementations such as that of FIGS. 1A-1B, a harvester 2 is configured to harvest crops through the row units 14 disposed on the corn header 12, as would be readily appreciated.

Various harvester 2 configurations are possible and known in the art. In the implementation of FIGS. 1A-1B the harvester 2 includes a header 12 including a plurality of row units 14 divided by dividers 16.

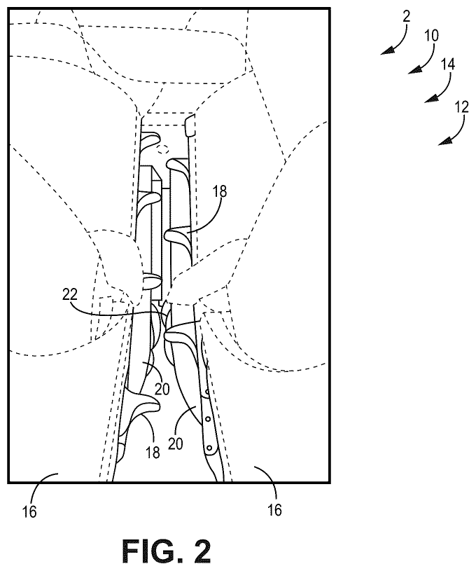

In various implementations, each row unit 14 may include gathering chains/fingers 18 located above the stripper plates 20, where the gathering chains 18 gather or pull the ears into the harvester 2 after the ears have been stripped from the stalks by the stripper plates 20, shown for example in FIG. 2. A row unit 14 may also include one or more stalk rolls 22 typically below the stripper plates 20 to crumple or otherwise pull stalks towards the soil. The typical operation of a corn header 12 row unit 14 is readily appreciated and understood by those of skill in the art. As would be understood, the plurality of row units 14 on a header 12 are typically substantially identical, while some variances are possible.

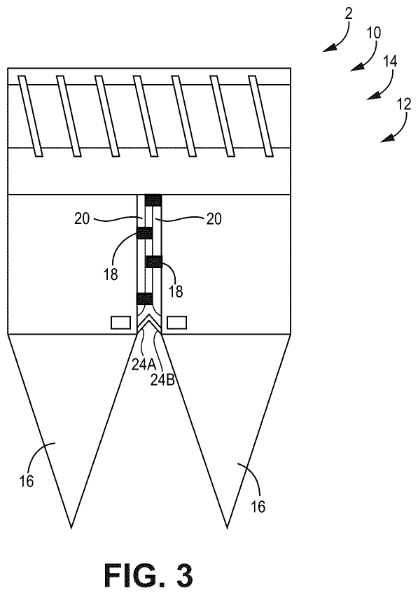

Returning to FIGS. 1A-1B, the row units 14 may include one or more sensing members 24A, 24B described in further detail below, such as in relation to FIG. 3. As shown in the implementation of FIGS. 1A-1B, the sensing members 24A, 24B according to certain implementations are in operational communication via a wired or wireless connection (not shown) with an operations unit 26, which may be located in the cab of the vehicle or harvester 2.

In various implementations of the system 10, the operations unit 26 comprises the various processing and computing components necessary for the operation of the system 10, including receiving, recording and processing the various received signals, generating the requisite calculations and commanding the various hardware, software and firmware components necessary to effectuate the various processes described herein. That is, in certain implementations, the operations unit comprises a processor that is in communication with memory and an operating system or software and sufficient media to effectuate the described processes, and can be used with an operating system 25, memory/data storage 30 and the like, as would be readily appreciated by those of skill in the art. It is appreciated that in certain implementations, the data storage 30 can be local, as shown in FIGS. 1A-1B, or cloud-based 32, or some combination thereof.

In various implementations, the system 10 operations unit 26 can comprise a circuit board, a microprocessor, a computer, or any other known type of processor or central processing unit (CPU) 27 that can be configured to assist with the operation of a system, such as the device disclosed or contemplated herein. In further embodiments, a plurality of CPUs can be provided and operationally integrated with one another and the various components, as utilized in other applications including the contemporaneously-filed applications incorporated by reference. Further, it is understood that one or more of the operations units 26 and or its processors can be configured via programming or software to control and coordinate the recordings from and/or operation of the various sensor components such as the sensing members 24A, 24B, as would be readily appreciated.

In certain implementations, the system 10 and/or operations unit 26 may utilize GPS 28 and a database 30 or other storage device such as the cloud 32, shown in FIGS. 1A-1B, to store and create row-by-row maps of shelled ear events (E_{d}). As discussed herein, shelled ear events (E_{d}) can include various events relating to the harvested crop, and occur when the measured stalk data (Dₘ) exceeds a defined threshold (Dₜ), as described below.

Further, the system 10 may be configured to numerically display the total number of shelled ear events (E_{d}) and/or an instantaneous rate of shelled ear events (E_{d}) on an in-cab or remote display, such as the display 34 shown in FIGS. 1A-1B. Various display 34 types are of course possible and are known in the art, such as the InCommand® display from Ag Leader.

In certain implementations, the header 12 height settings can be recorded and logged, such as via an on-board database 30 and/or cloud 32 storage system. In some implementations, the system 10 settings are recorded and logged with reference to the vehicle position, such as the GPS 28 position, as would be readily apparent to those of skill in the art from the incorporated references. In these and other implementations, the system 10 may create and display maps to provide insights into crop conditions and performance, such as via a display 34.

In these and other implementations, the system 10 may analyze the recorded data to determine causes of low yields. For example, a low header 12 height may indicate a lodged stalk area or short corn due to a wet area. Knowledge of yield loss issues may help operators and other stakeholders maximize yields in subsequent plantings.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/445,161, filed Jun. 18, 2019, entitled “Agricultural Systems Having Stalk Sensors and/or Data Visualization Systems and Related Devices and Methods,” U.S. patent application Ser. No. 16/800,469, filed Feb. 25, 2020, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. Patent Application 63/048,797, filed Jul. 7, 2020, entitled “Apparatus, Systems, and Methods for Grain Cart-Grain Truck Alignment and Control Using GNSS and/or Distance Sensors,” U.S. Patent Application 63/074,737, filed Sep. 4, 2020, entitled “Apparatus, Systems and Methods for an Electric Corn Head,” U.S. Patent Application 63/137,946, filed Jan. 15, 2021, entitled “Apparatus, Systems, and Methods for Row Crop Headers,” U.S. patent application Ser. No. 17/226,002, filed Apr. 8, 2021, and entitled “Apparatus, Systems and Methods For Stalk Sensing,” and U.S. patent application Ser. No. 17/225,740, filed Apr. 8, 2021, and entitled “Devices, Systems, and Methods For Sensing The Cross-Sectional Area of Stalks,” each of which are incorporated herein by reference.

Continuing with FIG. 2, when corn ears enter a row unit 14 at or slightly below the stripper plate 20 height, the stalk rolls 22 may thresh or shell off kernels from the ear thereby causing header loss and reducing overall yield. As would be appreciated, this type of yield loss and harvester error often goes unnoticed or unaccounted for due to the periodic nature of the error and difficulty in visualizing such error from the cab of a harvester 2.

In some implementations, the harvester 2 may include a header warning system 10 constructed and arranged to signal an operator when the height of the header 12 is at an incorrect height and causing yield loss. In various implementations, the system 10 signals an operator that the header 12 is too high and therefore shelling ears causing yield loss. This signal or warning may allow an operator to act and lower the header 12 to prevent any further yield loss due to this type of header error. In certain implementations, the system 10 may automatically lower to the header 12 when shelling conditions are detected, as will be explained further below. The header 12 may be lowered dynamically and/or incrementally until the stripper plates 20 are below the stalk ear height.

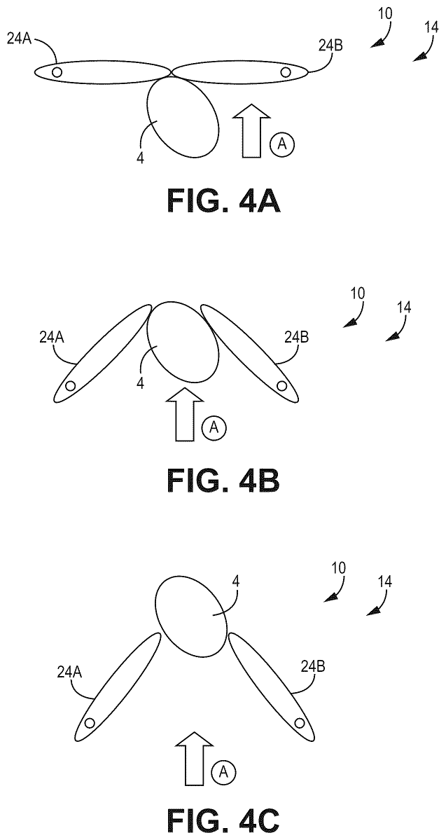

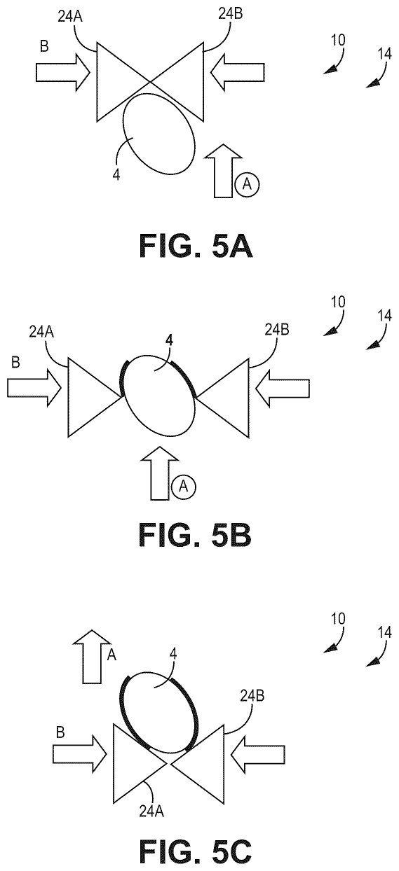

In various implementations, the row units 14 may include one or more sensing members 24A, 24B near the stripper plates 20, as shown in FIG. 3. In various implementations, the sensing members 24A, 24B are located just below the stripper plates 20. Exemplary sensing members 24A, 24B are shown in FIGS. 4A-5C.

FIGS. 4A-C show one implementation of the system 10 sensing members 24A, 24B where the sensing members 24A, 24B are pivotally attached to the row unit 14. In these and other implementations, the sensing members 24A, 24B are pivotally attached to the row unit 14 such that as a stalk 4 passes through the row unit 14 in the direction of reference arrow A, the sensing members 24A, 24B correspondingly pivot, thereby generating displacement data. The pivoting movement of the sensing members 24A, 24B may be detected by various sensors and used for various harvesting methods and metrics.

FIGS. 5A-C depict an alternative implementation of the sensing members 24A, 24B. In this implementation, the sensing members 24A, 24B are not pivotally attached to the row unit 14 but rather move laterally with respect to the row unit 14. That is, in these implementations, the sensing members 24A, 24B may be urged towards the center of the row unit 14, in the direction of reference arrow B, in their neutral state and urged apart, in the direction opposite of reference arrow B, when a stalk 4 passes through the row unit 14. As the sensing members 24A, 24B move with respect to the row unit 14 various data is generated regarding the orientation and/or movement of the sensing members 24A, 24B that may be utilized by the system 10, as will be discussed herein.

Various alternative sensing members 24A, 24B and systems are described in U.S. application Ser. No. 17/013,037 entitled “Apparatus, Systems and Methods For Stalk Sensing,” filed on Sep. 4, 2020, U.S. application Ser. No. 16/800,469, entitled “Vision Based Stalk Sensors and Associated Systems and Methods,” filed on Feb. 28, 2020, and U.S. application Ser. No. 16/445,161, entitled “Agricultural Systems Having Stalk Sensors and/or Data Visualization Systems and Related Devices and Methods,” filed Jun. 18, 2019, and other applications incorporated by reference herein.

When a header 12 is at the improper height, such as being too high, a corn ear may come into contact with the stripper plates 20 and/or sensing members 24A, 24B, causing yield loss as described above. When a corn ear contacts the sensing members 24A, 24B, the sensing members 24A, 24B may be urged into an extreme open position, or position beyond the typical range, as would be appreciated, or otherwise caused to move/rotate a greater distance and/or for a longer duration than when only contacting a stalk 4. This is because a corn ear typically has a greater diameter than a stalk 4. This type of contact and movement of the sensing members 24A, 24B is abnormal and can be distinguished by the system 10 from the signal generated by the sensing members 24A, 24B when a stalk 4 is passing through.

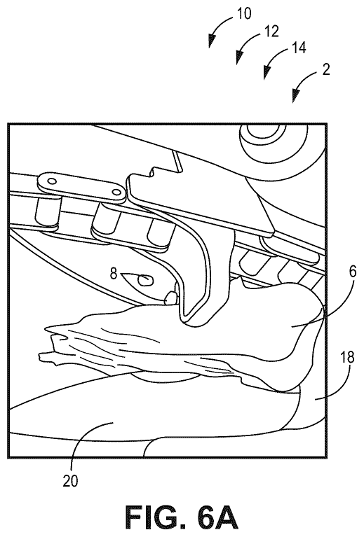

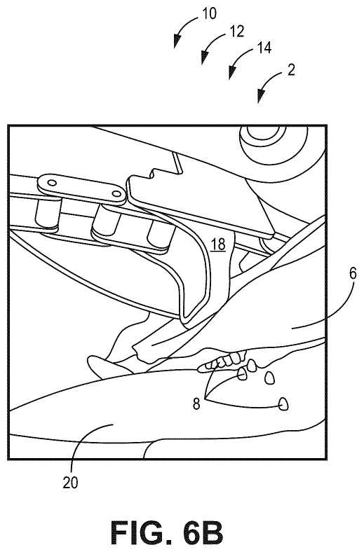

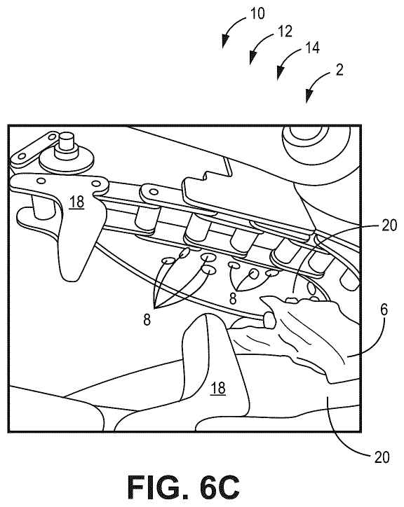

FIGS. 6A-C show an exemplary implementation of the header 12 being too high and causing lost yield. In FIG. 6A the header 12 is too high causing an ear 6 to enter into the gap between the stripper plates 20, instead of the optimal position where the ear remains above the stripper plates. As the ear traverses the row unit 14, the corn ear 6 is shelled and kernels 8 fall from the ear 6, as shown in FIG. 6B. Continuing to FIG. 6C the corn ear 6 may fall entirely below the stripper plates 20 and cause lost yield for the entire ear 6, alternatively the ear 6 may ultimately be gathered by the harvester 2 but only after kernels are separated from the ear 6 and lost to the ground.

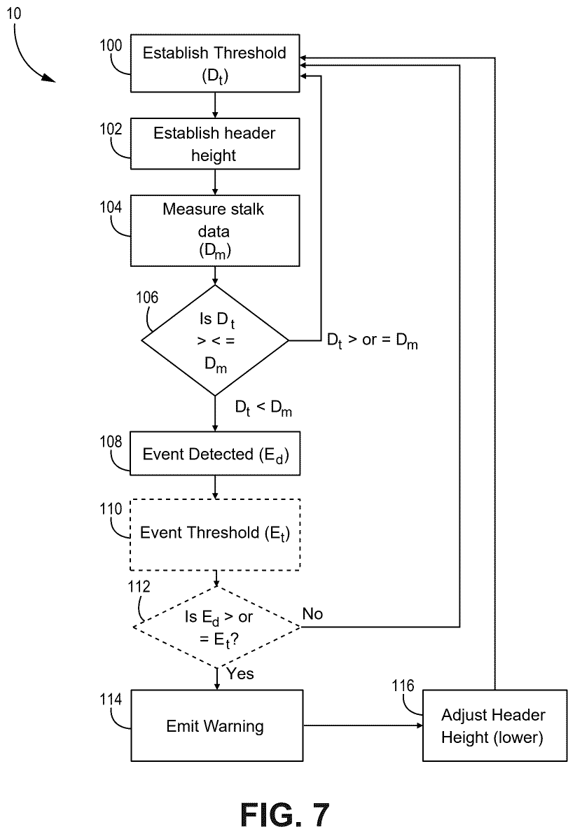

Turning now to FIG. 7, in various implementations, the system 10 is configured to execute a series of steps, each of which is optional and may be performed in any order or not at all. In one optional step, the system 10 is constructed and arranged to access or establish a threshold (Dₜ) (box 100). In various implementations, the threshold (Dₜ) is established (box 100) by an operator, whereby an operator enters the threshold (Dₜ) value into the system 10. In an alternative implementation, the system 10 establishes the threshold (Dₜ) (box 100) by deriving or otherwise accessing the threshold (Dₜ) from historical harvest data, such as by using various machine learning techniques and methods, as would be understood.

In certain implementations, the threshold (Dₜ) is a stalk data threshold (Dₜ), or other value that may be detected be the header 12 and/or sensing members 24A, 24B, such as a stalk perimeter, stalk diameter, displacement of sensing members 24A, 24B, such as by magnetic readings, or width measurement. In various implementations, the threshold (Dₜ) is the value over which the system 10 recognizes that it is not in contact with a stalk 4 but rather an ear 6 or other item of foreign material.

In one such example, the threshold is a diameter threshold (Dₜ) and more specifically in certain implementations a diameter threshold (Dₜ) of 1.5 inches. In an alternative implementation, the deflection time threshold (Dₜ) is defined such that a longer deflection period at a given harvester 2 speed is indicative of an ear 6 or other foreign matter in contact with a stalk 4, as would be readily appreciated.

The example discussed herein will use a diameter threshold (Dₜ), but it would be readily understood the certain modifications may be made to the overall system 10 to utilize various alternative data inputs.

In a further optional step, the system 10 establishes header 12 height. In various implementations, the height of the header 12 height is obtained via a sensor or other known mechanism on the header 12 or harvester 2.

In another optional step, the system 10 may measure stalk data to generate measured stalk data (Dₘ) via the sensing members 24A, 24B (box 104) as the harvester 2 traverses a field. Further, as noted above, the system 10 may utilize various measured stalk data (Dₘ) such as size, diameter, perimeter, deflection time, and/or width to detect shelled ear events.

In another optional step, the system 10 compares the threshold (Dₜ) to the measured stalk data (Dₘ) (box 106)—in one specific example a width threshold (Dₜ) is compared to measured width as an aspect of measured stalk data (Dₘ). In this specific example, in circumstances where the size threshold (Dₜ) is greater than or equal to the measured size that is an aspect of measured stalk data (Dₘ), a shelled ear event is not detected the harvester 2 and system 10 continues operating at its current state.

In circumstances where the size threshold (Dₜ) is less than the measured size data that is an aspect of measured stalk data (Dₘ), a shelled ear event (E_{d}) is detected (box 108). In certain implementations, the system 10 defines a start of a shelled ear event (E_{di}) when a threshold (Dₜ) is exceeded. The system 10 may also determine the end of a shelled ear event (E_{df}) when one or more measured stalk data (Dₘ), such as diameter, size, or deflection time, returns to below or within a defined threshold (Dₜ) range.

When a shelled ear event (E_{d}) is detected (box 108) the system 10 may then emit a warning (box 114) altering an operator of the event. In various implementations, the warning is a visual, audio, or other warning that will be brought to the attention of the operator, as would be readily understood by the skilled artisan.

In various alternative implementations, an alarm and/or signal is not emitted after a single shelled ear event (E_{d}), but rather the system 10 indicates to an operator or otherwise records that a shelled ear event (E_{di}) has begun after an event threshold (Eₜ) has been reached. Certain non-limiting examples of an event threshold (Eₜ) being a certain number of shelled ear events (E_{d}) have been recorded; when a shelled ear event (E_{d}) lasts for a certain period of time or exceeds a time event threshold (Eₜ); or when another algorithmic parameter is met or has been exceeded as defined by the particular implementation of the system 10 in operation.

In certain of these implementations, an event threshold (Eₜ) is established (box 110) by the system 10. In various implementations, the event threshold (Eₜ) may be entered by an operator, derived from historical harvest data, and/or otherwise established via computerized methods as would be appreciated, such as via a system update to the software and/or firmware. In some implementations, the event threshold (Eₜ) is a defined number of events, a defined time, and/or other algorithm selected to maximize detection of shelled ear event and lost yield while minimizing nuisance alarms. It is also readily appreciated that in certain implementations, the operator has the ability to mute the alerts/alarms, as would be readily appreciated.

In one example, the system 10 compares the number of events detected (E_{d}) to the threshold number of events (Eₜ) (box 112) and emits an alarm (box 114) after a set number of shelled ear events (E_{d}) exceeds a threshold number of events or event threshold (Eₜ) in a certain period of time. In various implementations, the threshold (Eₜ) may be a number of shelled ear events (E_{d}) per minute, a percentage of shelled ear events (E_{d}) over a period of time, area, or stalk count, or a number of shelled ear events (E_{d}) per area. In various implementations, the system 10 may utilize one or more event thresholds (Eₜ) to trigger the alarm.

In these and other implementations, the alarm may indicate to an operator that the height of the header 12 is causing yield loss. In another optional step, the operator may choose to adjust the header 12 height (box 116), such as by lowering the header 12. In some implementations, the header 12 is adjusted (box 116) manually, such as in small increments until the alarm ceases. The increments may be of about one (1) inch, although other amounts are possible as would be understood by those of skill in the art. In alternative implementations, the header 12 height may be adjusted (box 116) automatically until the alarm ceases, such as via actuators and/or other understood commanded heigh adjustment mechanisms. In various implementations, the header 12 may be adjusted at a certain rate such as about one (1) inch per second or another rate as would be appreciated.

In various implementations utilizing automatic lowering of the header 12 upon exceeding the event threshold (Eₜ), the corn header 12 may be automatically lowered in increments until the alarm ceases or the header 12 reaches a user entered minimum height.

In some implementations, the system 10 may automatically raise the header 12 in small increments, manually or automatically, until the alarm is triggered or the header 12 reaches a maximum height, which may be defined and/or stored within the system, as would be appreciated. In certain implementations, the header 12 may be raised when no shelled ear events have been detected for a threshold period of time, such as about fifteen (15) seconds. In another implementation, the header 12 may be raised after the harvester 2 has traveled more than a threshold distance, such as about one-hundred (100) feet. Various alternative circumstances for raising a header 12 are possible and would be understood by those of skill in the art.

In various implementations, cessation of the alarm may signal to the operator that the header 12 is at a proper height such that unnecessary yield loss from shelled ear events is no longer occurring. In some implementations, the alarm will cease when the number of shelled ear events (E_{d}) falls below the set threshold value (Eₜ), or other threshold is no longer being met or exceeded as applicable to a particular implementation. Further alarm types and patterns would be readily appreciated by the skilled operator.

Although the disclosure has been described with references to various embodiments, persons skilled in the art will recognized that changes may be made in form and detail without departing from the spirit and scope of this disclosure.

What is claimed is:

1. A method for controlling header height comprising:
generating a signal as an object passes through a row unit;
establishing a signal threshold, wherein when the signal threshold is exceeded a shelled ear event is detected;
comparing the signal to the signal threshold; and
adjusting a header height when the signal exceeds the signal threshold.

2. The method of claim 1, wherein the signal comprises at least one of a stalk size, a deflection distance, and a deflection time.

3. The method of claim 1, further comprising emitting an alarm when the signal exceeds the signal threshold.

4. The method of claim 3, further comprising ceasing the alarm when the signal no longer exceeds the signal threshold.

5. The method of claim 1, further comprising emitting an alarm when the signal exceeds the signal threshold after a time threshold is exceeded.

6. The method of claim 1, wherein the header height is incrementally lowered until the signal no longer exceeds the signal threshold.

7. The method of claim 1, further comprising creating a row by row map of shelled ear events.

8. The method of claim 1, further comprising displaying a total number of shelled ear events.

9. The method of claim 1, wherein the signal threshold is established from historical harvest data and machine learning.

10. A method for controller header height comprising:
detecting a shelled ear event via:
measuring stalk data; and
comparing measured stalk data to a defined threshold,
wherein when the measured stalk data exceeds the defined threshold a shelled ear event is detected; and
lowering a header in response to detected shelled ear events.

11. The method of claim 10, further comprising defining an end of the shelled ear event when the measured stalk data is below the defined threshold.

12. The method of claim 11, wherein the header is lowered incrementally lowered until the end of the shelled ear event.

13. The method of claim 10, wherein the defined threshold is user entered.

14. The method of claim 10, wherein the defined threshold is established from historical harvest data and machine learning.

15. The method of claim 10, wherein the stalk data is one or more of stalk perimeter, stalk diameter, sensor displacement, and width measurement.

16. The method of claim 10, further comprising defining an event threshold, wherein the header is lowered in response to detected shell ear events after the event threshold is exceeded.

17. The method of claim 16, wherein the event threshold is a period of time or a number of shelled ear events.

18. The method of claim 10, further comprising displaying a total number of shelled ear events.

19. A method for controlling a corn header comprising:
establishing a stalk data threshold, wherein when the stalk data threshold is exceeded a shelled ear event is detected;
measuring stalk data via one or more sensors;
comparing measured stalk data to the stalk data threshold;
recording a start of a shelled ear event when the measured stalk data exceeds the stalk data threshold;
recording an end of the shelled ear event when the measured stalk data returns to below the stalk data threshold; and
lowering the corn header until the end of the shelled ear event.

20. The method of claim 19, further comprising raising the corn header to a defined height after a defined period of no shelled ear events.
